(19) United States
(12) Patent Application Publication
(10) Pub. No.: US 2015/0072790 A1
(43) Pub. Date: Mar. 12, 2015

(54) GAMING ACCESSORY

(71) Applicant: DAVID KOTKIN, MIAMI, FL (US)

(72) Inventor: DAVID KOTKIN, MIAMI, FL (US)

(21) Appl. No.: 14/481,340

(22) Filed: Sep. 9, 2014

Related U.S. Application Data
(60) Provisional application No. 61/875,389, filed on Sep. 9, 2013.

(51) Int. Cl. A63F 13/245; A63F 13/25; A63F 13/214; A63F 13/837; A63F 13/211

(52) U.S. Cl. CPC A63F 13/245; A63F 13/837; A63F 13/211; A63F 13/214; A63F 13/25
USPC 463/38; 463/37

(57) ABSTRACT

A gaming accessory is provided herein to enhance the playability of video games. A motion actuated controller is provided wherein the controller provides for enhanced realism and simplicity in interacting with the game. Additionally, a proximity sensor may be provided wherein the motion actuated controller actuates a feature of the video game based on the proximity of a player relative to the proximity sensor.

### CROSS-REFERENCE TO RELATED APPLICATIONS

The present application claims priority to co-pending Provisional Patent Application No. 61/875,389, filed on Sep. 9, 2013, entitled “GAME CONTROLLER ACCESSORY”; that application being incorporated herein, by reference, in its entirety. Additionally, the present application incorporates by reference herein, the specifications and drawings of Provisional Patent Application No. 61/452,902, filed on Mar. 15, 2011 and entitled “GAME CONTROLLER ACCESSORY”, U.S. patent application Ser. No. 12/782,089, filed on May 18, 2010, entitled “DEVICE FOR ENHANCING OPERATION OF A GAME CONTROLLER AND METHOD OF USING THE SAME”, U.S. patent application Ser. No. 13/421,395, filed on Mar. 15, 2012, entitled “GAME CONTROLLER ACCESSORY”, Provisional Patent Application No. 61/179,551, filed on May 19, 2009 and 61/306,211, filed on Feb. 19, 2010.

### BACKGROUND OF THE INVENTION

The present invention relates to a game controller accessory, and more particularly, to a game controller accessory that can be used with existing games and/or game controllers to more easily interact with the game.

Video game controllers are known. Additionally, devices for enhancing the playability of video game controllers are also known. For example, U.S. Pat. No. 6,557,853 to Huettlinger, filed on Jan. 1, 2002, discloses a strap device for use with a video game that, among other things, facilitates the use of joystick, provides cushioning to reduce the risk of user injury and is adaptable to work with most standard video game joysticks. U.S. Pat. No. 8,784,208 to Borrel, filed on Sep. 14, 2009, discloses a game control thumb grip for controlling gaming analog sticks. U.S. Patent Application Publication No. 2010/0298053 to Kotkin discloses a device for enhancing operation of a game controller and method of using the same.

What is needed are accessories that fit on existing game controllers to enhance their operation.

Additionally, game controller accessories for use in shooting games are known. U.S. Pat. No. 8,419,541 to Mao discloses a smart shell to a game controller which can be clipped to a game controller by an end user and released after a game is played, wherein signals can flow from the video game console back to the shell to operate tactile feedback motors, lights and speakers. According to the '541 patent, the smart shell can be in the shape of a gun with sensors to determine which grips are being held and a sensor to determine if a player is holding the gun's scope to his face. Additionally, the '541 patent discloses that logic using the three sensors can robustly determine whether the user is holding the gun as a pistol, machine gun, or a sniper rifle, and can reflect the player's choice of style in the video game.

What is also needed is a game controller that, itself, provides full video game controller functionality, including for shooting games.

### SUMMARY OF THE INVENTION

It is accordingly an object of this invention to provide devices that enhance the playability of video games. In one particular embodiment of the invention, a motion game controller is provided wherein the game controller, itself, is made in the form of a gun. In a further particular embodiment, the game controller includes a proximity sensor that is used to actuate a feature of the video game based on the proximity of a player relative to the proximity sensor.

Although the invention is illustrated and described herein as embodied in a gaming accessory, it is nevertheless not intended to be limited to the details shown, since various modifications and structural changes may be made therein without departing from the spirit of the invention and within the scope and range of equivalents of the claims.

The construction of the invention, however, together with the additional objects and advantages thereof will be best understood from the following description of the specific embodiments when read in connection with the accompanying drawings

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is a side perspective view of a game controller including a palm actuator in accordance with one particular embodiment of the present invention;

FIG. 2 is a partial front perspective view of the game controller and palm actuator of FIG. 1;

FIG. 3 is a rear view of a controller having accessories in accordance with one particular embodiment of the present invention;

FIG. 4 is a perspective view of a jel pad for a joystick of a gaming controller;

FIG. 5 is a perspective view of a jel pad for a D-pad of a gaming controller;

FIG. 6 is a partial perspective view of a video game controller including a trigger accessory affixed thereto;

FIG. 6A is a trigger accessory in accordance with one particular embodiment of the invention;

FIG. 7 is a perspective view of a video game controller in accordance with one particular embodiment of the invention;

FIG. 8 is a block diagram of a video game controller in accordance with another particular embodiment of the present invention;

FIG. 8A is a block diagram of a removable clip that can be associated with the video game controller of FIG. 8.

FIG. 9 is a block diagram of a video game controller in accordance with one particular embodiment of the present invention.

### DETAILED DESCRIPTION OF THE PREFERRED EMBODIMENTS

The present invention provides various embodiments of gaming accessories for enhancing the playability of video games.

Palm Actuator:

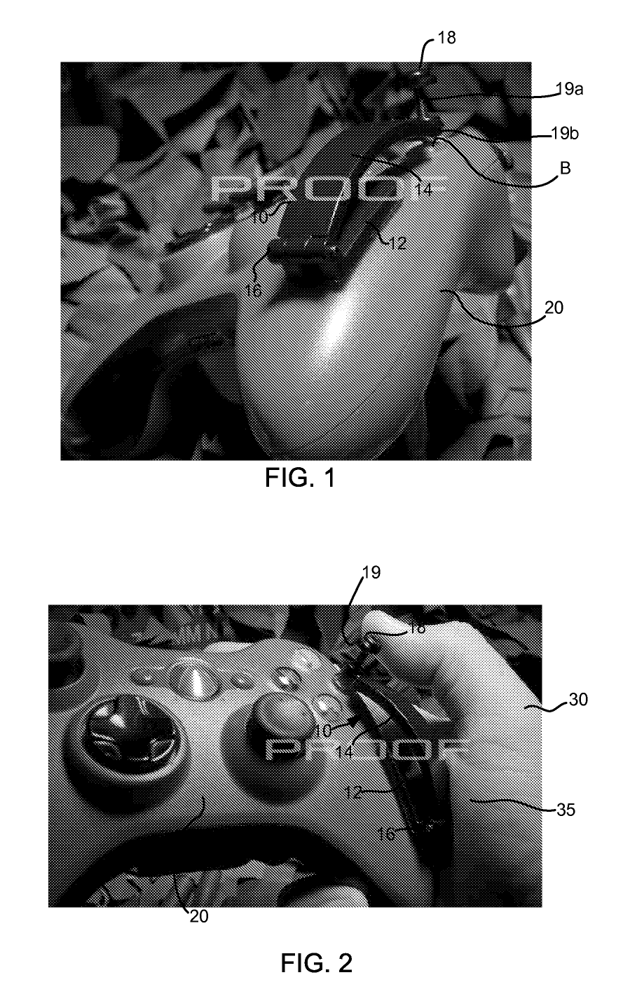

Referring now to FIGS. 1 and 2 of the instant application, there is shown one particular embodiment of a accessory for enhancing the playability of a video game. More particularly, a palm actuator 10 is provided that can be added on to an existing game controller 20 or game controller accessory. The palm actuator 10 permits a user to execute a button press merely by squeezing the controller 20 in the user's hand 30.

The palm actuator of FIGS. 1 and 2, can be affixed to a game controller over one of the buttons X, Y, A or B. In one particular embodiment, the palm actuator 10 is a stick on actuator with a base portion 12 that sticks to, and closely conforms to, the curvature of the face of the game controller 20 or to a skin or shell that is placed over the game controller 20. The base portion 12 may be attached to the controller 20 or skin using an adhesive or double stick adhesive pad. A spring arm 14 is pivotally (or hingedly) attached at one end to the base portion 12 by pivot or hinge 16. A head portion 18 at the other end of the spring arm 14 is disposed over one of the buttons X, Y, A or B, as shown in FIGS. 1 and 2. As can be seen, when gripping the game controller in the hand 30 of the user, the spring arm 14 is in close proximity to the user's palm 35. Squeezing the spring arm 14 towards the base portion 12 with the palm 35 of the user's adjacent hand 30 will cause the head portion 18 to actuate the underlying button (B in FIGS. 1 and 2). A screw attachment or fine tuning mechanism 19 having a screw 19a and pad 19b, can be set through the head portion 18, so as to adjust the height of the head portion 18 above the underlying button B, and thus, to fine tune the amount of pressure required on the spring arm 14 to actuate the button B underlying the head portion 18.

Consequently, the spring arm 14 can be used to actuate the underlying button B with a “palm click” or squeeze of the user's hand 30. This permits actuation of a button while the user's thumb remains on the joystick. The base portion 12 can be made as part of a game controller 20 or skin accessory, or can be used as a retrofit to an existing game controller 20 or skin accessory. The palm actuator 10 need only be stuck on to the controller 20 or skin in the manner shown in FIGS. 1 and 2, using an adhesive, or a physical attachment formed on the surface of the controller 20 or skin.

Jel Caps:

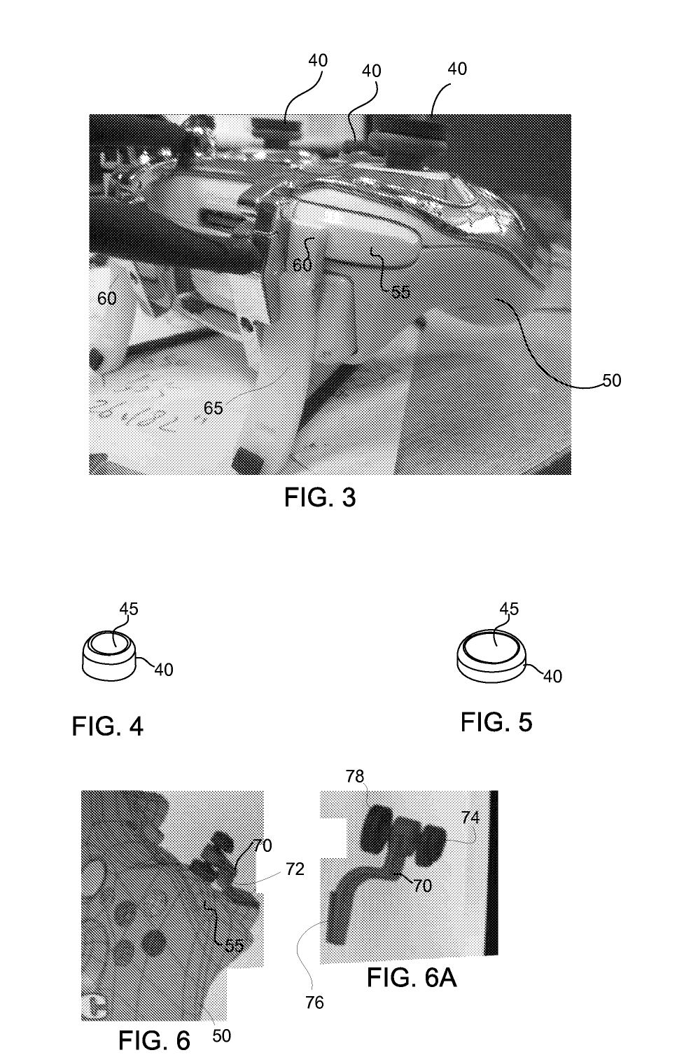

Referring now to FIGS. 3, 4 and 5, circular jel caps 40 are provided to be affixed to the top of the D-pad, which is the big grey circle on the XBOX controller 50, in-between the two joysticks. This raises the height of the D-pad controller, which means the thumb has less distance to travel when switching from the joystick to the D-pad. Such a jel or gel cap 40 can be made of a soft silicone, such as is used in making rubber toys. Additionally, the jel cap 40 can be made in different sizes, adapted to the surface of the joystick (as is the jel cap 40 of FIG. 4) or the D-pad (see, the flatter, larger diameter jel cap 40 of FIG. 5). Additionally, each jel cap 40 can include an indent 45 in the middle thereof, for ergonomic placement of the thumb pad for controlling the underlying controller. As can be seen more particularly from FIG. 3, the jel cap 40 can be stuck on to the D-pad and/or to the tops of the joysticks, with an adhesive or adhesive tape, such that nothing overlaps. Other types of joystick or thumb stick covers currently available are like swimmers caps over the joystick. This can interfere with movement.

Bionic Triggers:

Referring back to FIG. 3, a trigger enhancement or “bionic” trigger is provided. The bionic triggers make it so that, if you kick out the pedal 65, it now engages the bumpers. This means that you never have to take your index fingers off triggers.

In the particular embodiment of FIGS. 6 and 6A, stick-on bionic triggers 70 are shown. Bionic triggers can be stuck to a base portion of the controller using an adhesive or adhesive tape 76, with the head located over the bumper 55. These add-on triggers 70 performs the same button actuation as without them, however, the user's index finger has more support or comfort with the ledge (i.e., an ergonomically shaped raised portion or bend in the lever body). Just a little push up on the levers 72 and the bumpers 55 are pressed by the contact pad 78. Screw and cap 74 adjust sensitivity can be provided to adjust the sensitivity of the levers 72 and to adjust the preload on the triggers and bumpers 55. This means less trigger travel.

Motion Gun Controller or Actuator:

At present motion guns are offered for the Wii and PS3 gaming systems (e.g., the PS3 Move gun controllers). Such existing motion guns have not been successful to date, in part because:

1) The motion has to do with wireless signals and tracking capture that has to be calibrated in a big room. The motion is too extreme to shoot targets and you have to stop suddenly to stay in the frame. Standing and exertion are requirements and if they made a competitive motion first person shooter (FPS) online, you would be disadvantaged.

2. The gun controllers are just frames that have inserts for the Wii and MOVE controller. See, for example, U.S. Pat. No. 8,419,541 to Mao. These controllers are used for a wide variety of games, from bowling games to dancing games. They were not targeted to the first person shooter, so too many compromises were made.

3. More so than a traditional controller, a gun controller is in front of you. The “Buck Rogers super soaker” look reminds more mature gamers that they have to grow up.

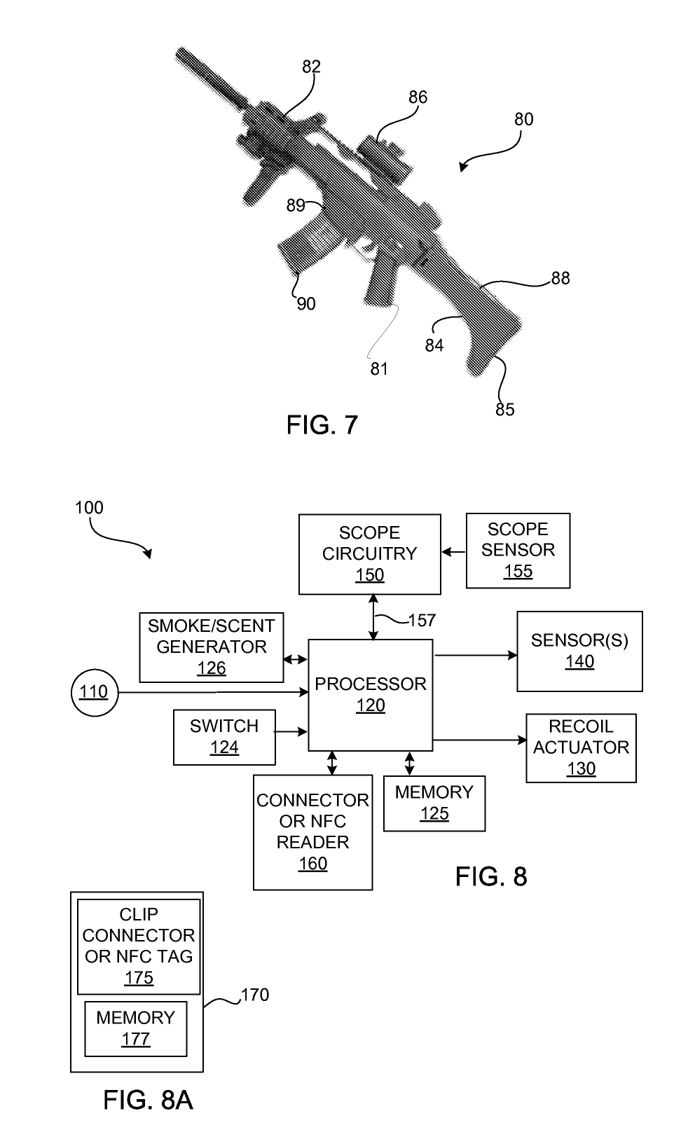

However, referring now to FIGS. 7-8A, one particular embodiment of a video game gun controller or “motion gun controller” 80 which is motion actuated will be described. The motion gun controller 80 of FIG. 7 differs from existing gun controllers in that, among other things, the gun controller 80 of FIG. 7 incorporates the controller circuitry 100 therein. In other words, the controller 80 is not merely a shell in which a game controller can be placed, but rather, is the actual game controller having a gun shaped housing 82 that fully encapsulates the controller circuitry 100, which is sealed therein. The main components of the controller circuitry 100, including the processor 120 and motion sensor 110, include no other housing than the gun shaped housing 82.

The motion game controller 80 includes a motion sensor 110 within the motion gun controller 80. This motion sensor 110 is actually integral to the motion gun controller, i.e., is incorporated as part of the electronics inside the housing 82, and not as part of a stand-alone controller removably mated with a gun shaped shell, as disclosed in U.S. Pat. No. 8,419,541. In one particular embodiment, the motion sensor 110 includes a gyroscope housed inside the controller. In another particular embodiment, the motion sensor 110 is a multi-axis acceleration sensor or accelerometer. The use of the motion sensor 110 provides joystick like aiming of the motion gun controller merely by moving the motion gun controller 80.

More particularly, the motion sensor 110 provides a signal to the processor 120 operating in the motion game controller 120 that indicates that the gun controller 80, and in particular, the business end of the gun controller 80 (i.e., at or near the distal end of the barrel) has been moved. In particular, an motion sensor 110 (i.e., accelerometer and/or gyroscope) in the motion gun controller 80 senses that the end of the motion gun controller has moved up or down, left or right and the game view is changed correspondingly. The motion sensor 110 also provides the processor 120 with information about how much, and in what direction, the end of the gun has moved. The processor 120, which can be a microprocessor, microcontroller, dedicated configuration of hardwired circuitry and/or the like, processes the information in accordance with a set of instructions embodied in software or firmware stored in a non-transitory storage or memory device 125 associated with the processor 120. In particular, the information received by the processor 120 from the motion sensor is translated into multi-axis coordinates that are used by the video game console (not shown) to update the display and game play. It is to be noted that such translation could be performed by a processor of the game console, rather than the processor 120 of the motion gun controller. In such case, the processor 120 would relay the signals from the motion sensor 110 to the game console for further processing. By using a motion sensor 110 having multi-axis detection, the tip of the gun controller 80 distal from the stock 85 and/or grip 81 can be analogized to the free end of a joystick with the resulting signals corresponding to motion of the motion sensor 110 along the joystick axes.

This permits the joystick operation of a standard controller to be integrated into the motion gun controller 80. For example, if the player tilts the gun to the left, the aim projected in the video game will tilt left. You could turn to the side, up or down and the results would be the same. Thus, aiming is performed using the intended joystick commands of a standard controller, but without the actual joystick. Rather, the gun is now the joystick. Aiming the gun up would be the same as pulling the joystick back. Thus, once calibrated to the game screen view, the end of the motion gun controller behaves like a floating joystick having the user as its base point. Advantages to this design include:

1. More accurate aiming with less exaggerated movements.

2. Any game that uses a standard controller could use the motion gun controller 80 of the present embodiment. Additionally, a converter could be provided for use with all computer games.

Such a motion gun controller 80, in accordance with the present embodiment, would provide 3D reality in your living room.

Additionally, the motion gun controller 80 of the present embodiment can be provided with an actuator 130 that gives real recoil. For example, a vibrating element can be provided in the stock of the incorporating such an actuator into the stock 84 of the motion gun controller 80 can result in the player receiving a slight (or even a strong) thump from the stock 84. In one particular embodiment of the invention, the stock 84 of the motion gun controller 80 can include an actuator at the butt end 85 of the stock 84 that provides a recoil thump in the player's armpit, when the motion gun controller 80 is held against the armpit. In one particular embodiment of the invention, a portion of the butt 85 may be spring mounted to the housing 82 such that the actuator 130 (when operated) causes the portion of the butt 85 to punch out from the housing slightly in sync with the firing of the gun controller 80, thus providing a recoil against the shoulder of the player. Alternately, an actuator can be provided in other parts of the motion gun controller 80 to simulate recoil such that every time the player fires the gun, they experience a feeling of recoil from the stock 84. Additionally, the motion gun controller 80 of the present embodiment can be used in a single or full auto mode, controlled by an on-board selector switch 124.

In one particular embodiment of the invention, the motion gun controller 80 can be configured so that, after firing for a predetermined amount of time, an optional fake smoke and scented fire smell can be emitted from the barrel, or another location, of the controller 80.

In another particular embodiment of the motion gun controller, a sensor 140 is provided to determine actuation of a feature of the controller by the user. For example, in one particular embodiment of the invention, the sensor 140 is a button or sensitivity strip 88, shown as a stripe on the butt of the gun controller in FIG. 7 for illustrative purposes, provided on the outside surface of the housing 82. The sensitivity strip 88 is employed such that, when the user goes to aim, the user's chin and side of the face hits the button or sensitivity strip 88, activating a feature, such as ZOOM or focus. However, if desired, the sensitivity strip 88 can be added elsewhere on the controller 80 and/or actuated by a different body part of the player. For example, a sensitivity button or strip 88 can be arranged on the controller such that ZOOM, focus or some other action is engaged when the stock 84 or another area is pressed by a body part, including a body part other than a finger. For example, in one embodiment, an action of the controller 80 can be activated by touching the stock 84 or scope 86 of the controller 80 of FIG. 7, or even by applying pressure to a sensitive portion of the controller 80 in some other way, such as by squeezing the end of the stock 84 into the shoulder of the user or by applying pressure to a portion of the controller 80 using the face and/or neck of the user. In another particular embodiment of the invention, the sensor 140 is a sensor incorporated in the butt end 85 of the stock 84 that is used to engage a ZOOM feature of the game when the stock 84 is pressed into the shoulder of the player.

As an alternate to the above-discussed sensitivity button or strip 88, another form of sensor 140 can be placed on the motion gun controller 80 that does not require actual contact with the button or strip 88, in order to produce a result. For example, sensor 140 can be chosen to include a proximity sensor, such as a heat or light sensor, or infrared beam could be configured to determine the proximity of the user to the stock or scope, to provide a zooming or other function. Additionally, if desired, the proximity sensor could be, or could include, a shadow activated motion detector or “shadow sensor” (i.e., a sensing circuit that detects motion by determining the changes or light difference in the shadow cast by a moving object). In particular, as the player leans towards the proximity sensor, the function is actuated. If the player then leans away from the proximity sensor, the function is discontinued. For example, in one particular embodiment of the invention, a player will tilt his or her head towards a proximity sensor (sensor 140) incorporated into or on the stock 84 in order to engage the ZOOM function or some other function controlled in the game.

In another particular embodiment, sensor 140 is a proximity sensor that includes a heat or infrared sensor can be used to sense the body heat of the user as he or she leans towards the proximity sensor. In another embodiment, a function can be actuated by the user leaning towards the proximity sensor and breaking a light beam. In a further embodiment, the proximity sensor can use a shadow sensor, light beam or ultrasound beam to detect proximity from light or other types of waves reflected from the user.

Note that, more than one of the foregoing types of sensor (i.e., sensitivity strip/button, pressure sensor, proximity sensor, etc), can be used as the sensor/sensors 140, without departing from the scope of the present invention.

Additionally, the motion gun controller 80 of FIG. 7 can be configured so that all buttons/triggers are where they should be for an actual gun. For reality, the gun controller of the present embodiment can be configured and programmed so that the device can only be “reloaded” once you physically remove and replace the “clip” 90 into the motion gun controller 80 into a magazine receiver 89 of the housing 82. Alternately, if desired, the gun controller can be “reloaded” by tapping the bottom of the “clip” or “cartridge” 90, rather than requiring reinsertion of the clip 90. It is contemplated that the game would track the number of bullets fired and the capacity of the engaged clip 90 and require the virtual changing of the clip 90 (by tapping the clip or removing and replacing the clip) once the number of bullets fired matches the clip capacity.

Similarly, in connection with some games, where appropriate, the controller 80 can be configured as another type of weapon, such as a grenade launcher that only works after the user has physically moved a part on the controller corresponding to the same part that is shown in the games.

In another embodiment of the motion gun controller 80 of FIG. 7, a scope 86 can be provided including a contact or proximity sensor 155 that is activated by being touched by the eye orbit or another body part of the user. Zooming happens when you look through the optics of the scope 86 that bring out the colors of the game more. Realism is enhanced by the sound of your real clip 90 changing as the user takes the eye off the scope 86 and/or by, optional fake smoke being faintly seen and smelled, creating a real 3d experience.

Additionally, although the motion gun controller 80 of FIG. 7 looks like a real gun, the gun is fake. It is intended that the motion gun controller will be produced following the same laws of an Airsoft gun even though nothing is fired for real. It will have a 3 millimeter orange marking at the end of the barrel, and in one desired method of sale, purchase will be restricted to individuals over the age of 18, due to the appearance of a real gun.

The motion gun controller of FIG. 7 can additionally, optionally, be configured such that:

parts can be interchangeble for left and right handed users;

fake grenade launcher and shotgun shells can be provided for loading fun;

the gun controller 80 can be transformed into different guns, such as a sniper rifle or machine pistol; and/or

the gun controller can fold down into a briefcase.

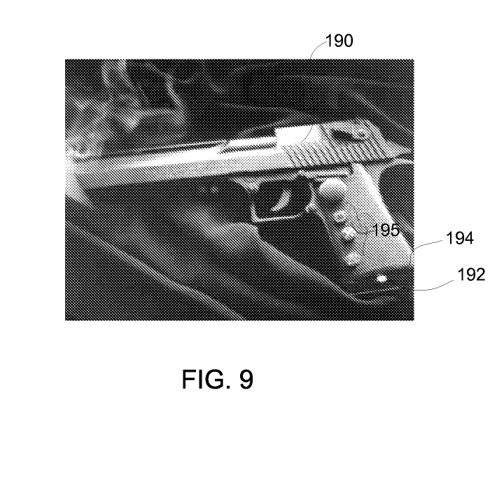

Similarly, all of the features listed above in connection with the motion gun controller 80 of FIG. 7 can additionally be adapted for use in connection with a handgun including some or all of the circuitry 100, as illustrated by the motion gun controller 190 of FIG. 9. In particular, the motion gun controller 190 of FIG. 9 can include, among other things, a smoke/scent generator unit 126, a recoil actuator 130, sensor(s) 140 (as described hereinabove), a scope sensor 155, controller buttons 124, a motion sensor 110, etc., all as described herein in connection with the controller 80 of FIG. 7. Additionally, a sensor 140 (i.e., sensitivity strip, proximity sensor, etc.) can be provided along the grip or barrel of the controller 190 to sense a user sighting along the barrel of the controller 190, if desired. Optionally, standard game control buttons 195 can also be placed on the motion gun controller 80, 190 such that every finger is on a button. This might provide a slight advantage over users using a regular game controller.

Additionally, further types of motion gun controllers can be provided. For example, there could be a combination of the software and/or hardware of the system and a gun controller 80, in accordance with the present embodiment, that assists in immersing the user into the world of the game. For example, it may be possible to purchase several different types of gun controller, or even gun controllers having different appearances, such as gun controller having the appearance of a golden gun. This can be integrated with the game hardware/software such that, when the user plays the game using the gold gun controller, in the game that golden gun appears on screen. Thus, specific guns, including very artistic ones with colors like HALO™ alien weapons can be made.

Similarly, the user may use a plurality of types of gun controllers in a single game. For example, in a Tomb Raider type game, the user could possibly switch between holstered pistol motion gun controllers and a shotgun style or grenade launching motion gun controller, thus triggering a switch between these weapons in the game. The user merely has to “register” the different weapon controllers with the game in advance, much in the same way that additional characters are added to the game SKYLANDERS™ by Activision. In particular, first person shooter games could be adapted so as to add weapons, based on the presence of a motion gun controller that can be linked to the game.

Thus, referring now to FIGS. 7-9, in one particularly preferred embodiment of the invention, the controller 80, 190 utilizes an accelerometer as the motion sensor 110 in the gun controller 80, 190 for home use. Consequently, the motion gun controllers 80, 190 are technologically improved over other gun controllers. Targeting is faster and more like a typical, non-gun type controller. Advantageously, the motion gun controller including a gyroscope or accelerometer makes the gun controller like having one giant joystick operating along a multi-axis coordinate system, thus magnifying the controller operations, but in a controlled way, so that movements are less drastic and require less effort in operation. Past gun controllers were directed towards aiming of the gun controller. However, they did not take into account that the display or screen is not realistic, nor does it reflect life. Basically, in past gun controllers, aiming was meant only to connect the user to a virtual world, in which aiming must constantly be pulled back within the lines defined by the screen, i.e., the demarcation of the virtual world. The problem of maintaining aiming within the lines of the screen is exacerbated by making movements of the controller too extreme to move the X to different points. Consequently, in past controllers, performance was sacrificed.

The present invention gives the user a gun controller that is exactly adapted for immersing the user into the virtual world, not just connecting the user to it. For the first time, the motion gun controller, in accordance with FIGS. 7-9 of the instant application, gives the shooter a competitive edge to win at home and online, by giving the user improved realism coupled with improved function (i.e., the user does not going through the signal for aiming, rather the reality of the controller provides the edge).

In a further embodiment of the invention, the motion gun controller 80, 190 can be used to even further immerse the player into the game. In particular, add-on accessories can be purchased for the motion gun controller which are then duplicated in the game in much the same way as new characters are introduced into SKYLANDERS™ by Activision. More particularly, a physical item purchased in the real world can be registered with the motion gun controller and duplicated in the game.

Referring back to FIGS. 7-9, the motion gun controllers 80, 190 include a cartridge, magazine or clip 90, 192 that comes standard with the controller 80, 190. However, in one particular embodiment of the invention, if a player wants a more powerful clip, or one having a greater capacity, the player can buy an add-on clip 90, 192 (at the store or through an online service) which clip 90, 192 has a characteristic or attribute different from the clip 90, 192 that came standard with the motion gun controller 80, 190. For example, if a player wants a clip 90, 192 having a greater capacity, the player can purchase a physical clip 90, 192 that has a greater capacity. The physical item (in this example, the clip 170) is then registered with the motion game controller 80, 190. For example, in one particular embodiment of the invention, the standard clip 90, 192 is ejected from the clip receiver 89, 194 of the motion gun controller 80, 190 and the new clip 170 is received in the receiver 89, 194, such that a connector 175 mates with a connector 160 in the receiver 89, 194. Alternately, an RFID tag 175 or other near field communication tag (NFC) can be detected by a NFC reader 160 of the motion gun controller 80, 190, when the new clip 170 is placed in close proximity. Thus, data stored in the new clip 170 can be read out by the processor 120 in the motion gun controller 80, 190 and the characteristics and attributes of the new clip 170 can be ported into the game such that the clip 170 is cloned in the game. For example, the clip 170 in the game would have the same number of rounds as the new clip 170 registered with the motion gun controller 80, 190. Similarly, if a clip 170 having a more powerful round is purchased (such as a .45 caliber round to replace the .22 round provided in the original clip), registration of the new clip 170 (which is a physical article existing in the real world) with the motion gun controller 80, 190 would cause the rounds fired in the game to change from .22 caliber to .45 caliber.

In one particular embodiment of the invention, at least one of the clip 170 or the motion gun controller 80, 190 includes a memory device 125, 177 including a writable memory register associated with a particular clip 90, 192, 170 that stores the number of bullets used in the game. For example, if a player has a seven round clip and uses five rounds before swapping the clip 90 for another clip 170, the system can record in the memory device 125 or 177 that the clip 90 has only two rounds left before requiring reloading (i.e., by tapping the clip or removing and replacing it). Thus, in the present embodiment, when a particular clip 90, 192, 170 is replaced into the motion gun controller 80, 190, the memory register associated with that particular clip 90, 192, 170 is read out and the information (in this example, the number of rounds remaining before requiring reloading) becomes part of the game.

In another embodiment of the invention, an add-on scope 86 can be provided for use with the motion gun controller 80, 190. In particular, if the motion gun controller 80, 190 has no scope 86, or if it is desired to upgrade the scope 86 that the motion gun controller 80, 190 has, a scope 86 existing as a physical article in the real world and having particular attributes can be purchased by the player and registered with the motion gun controller 80, 190. As discussed above, registration of the scope 86 with the motion gun controller can occur creating a connection 157 between scope circuitry 150 and the processor 120. This connection 157 can be created by by mounting the scope to the motion gun controller 80, 190 and, thus, engaging a connector on the motion gun controller with a connector on the scope, or by mounting the scope to the motion gun controller in order to have an RFID or other NFC tag read by an NFC reader of the motion gun controller, or by some other means. The scope 86, thus registered, can be synced with the game software to provide a more powerful scope 86 in the game (i.e., a scope having the attributes of the scope purchased by the player).

The types of add-ons available for the motion gun controller are not limited to the clip 90, 172, 192 and scope 86, as other add-ons are envisioned without departing from the scope of the invention. For example, in one particular embodiment of the invention, a stock can be purchased for the motion gun controller 190 of FIG. 9 or a replacement stock 84, having different attributes from the originally provided stock 84 (i.e., more steady, lighter, etc.), can be purchased for the motion gun controller 80 of FIG. 7, and can be duplicated, with its correspondingly changed attributes, in the game.

Additionally, items original to, or added-on to, the motion gun controller 80, 190 can have other attributes that enhance the virtual reality experience of the player. In one particular embodiment of the invention, the motion gun controller 80, 190 is provided with a scope 86 that can be interacted with realistically in order to enhance the game. For example, in one embodiment, if it is raining in the game, the system can be configured to require the user to periodically wipe the lens of the scope 86 to get rid of the rain on the game screen or (if the scope has visual enhancements) viewed in the scope 86. In another embodiment, if the scope becomes damaged on-screen, for example, in a game where the game screen display is “cracked” when a player is killed, the motion gun controller 80, 190 and/or the game may be configured to require the scope 86 to be changed out in order to eliminate the cracks on the game screen.

Additionally, in another particular embodiment, the scope 86 is provided with some actual magnification, so as to enhance the game screen (i.e., the television or monitor display) when viewed through the scope 86. Thus, in addition the game screen or display picture zooming, the scope can also be configured to magnify the view therethrough. Such magnification can be provided through an optical lens set or digital enhancement using the scope circuitry 150. In a further embodiment, the scope circuitry 150 can be provided with a laser dot that shines on the game screen and/or is viewed in the scope 86. For example, a laser dot is projected either from a portion of the scope 86 onto the television or display upon which the game is played, and/or is provided in the viewing portion of the scope 86, itself.

The above-described motion gun controllers 80, 190 can additionally be adapted for use in other types of weapons, items or tools in other kinds of games, as well (i.e., light sabers that change colors in reality and on-screen, different types of swords, such as a short sword, broadsword or claymore, the use of which is mirrored into the virtual world, etc.). Other examples of tools/weapons that could be used with a motion controller, as described herein, include, but are not limited to: other types of weapons, swords, bows and arrows, fishing rods, knives, etc. For example, a motion controller as described herein can be used in connection with a fishing game, wherein the user is provided with a standard reel and rod, the detected motion of which can be translated into the game as casting, reeling-in, or other fishing-related movements. Additionally, in accordance with the present invention, such a fishing rod/controller would be duplicated into the virtual world of the fishing game, and add-ons (such as better reels, different lures or sinkers, rods of different stiffnesses and/or lengths, etc.) could be purchased by the user and ported into the game (i.e., by near field communications, or some other mechanism) so as to improve the player's results in the game in correspondence to the improved fishing gear purchased and used by the player.

The present disclosure is provided to allow practice of the invention, after the expiration of any patent granted hereon, by those skilled in the art without undue experimentation, and includes the best mode presently contemplated and the presently preferred embodiment. Nothing in this disclosure is to be taken to limit the scope of the invention, which is susceptible to numerous alterations, equivalents and substitutions without departing from the scope and spirit of the invention.

We claim:

1. A video game controller for playing a video game interactively on a video game console, comprising:
video game controller circuitry;
a weapon shaped housing fully encapsulating said video game controller circuitry, said weapon shaped housing having a proximal end and a distal end;
said video game controller circuitry including a processor and a motion sensor configured to provide an input to said processor;
said motion sensor disposed in said housing at or near said distal end; and
said processor configured to receive movement signals from said motion sensor and provide them for updating game play of a video game.

2. The video game controller of claim 1, wherein the motion sensor senses motion along multiple axes.

3. The video game controller of claim 2, wherein signals from said motion sensor are translated into joystick coordinates in the video game

4. The video game controller of claim 3, wherein the weapon is a gun.

5. The video game controller of claim 4, wherein the gun includes a stock and the stock includes a sensor for detecting a body part of a user on the stock or moving relative to the stock.

6. The video game controller of claim 5, wherein the sensor is a sensitivity sensor detecting a body part of the user touching the stock or applying pressure to the stock.

7. The video game controller of claim 6, wherein the sensor causes a display of the video game to ZOOM in response to a detection of a body part touching or applying pressure to the stock.

8. The video game controller of claim 5, wherein the sensor is a proximity sensor detecting the proximity of a particular body part of a user relative to the stock.

9. The video game controller of claim 8, wherein the sensor actuates a feature of the video game.

10. The video game controller of claim 8, wherein the sensor causes a display of the video game to ZOOM in response to a detection of a body part of the user moving towards the stock.

11. The video game controller of claim 1, including at least one connector or reader configured to receive information from an add-on part removably engageable with the weapon shaped housing, said add-on part having particular attributes which are duplicated in the video game based on said received information.

12. The video game controller of claim 11, wherein the add-on part is a clip assigned a particular number or type of bullets.

13. The video game controller of claim 11, wherein the add-on part is a scope.

14. The video game controller of claim 11, wherein the add-on part is a stock.

15. The video game controller of claim 1, wherein the housing additionally has video game controller buttons disposed thereon.

16. The video game controller of claim 1, wherein the controller additionally includes a device for producing simulated smoke.

17. A video game controller accessory palm actuator, comprising:
a base portion;
a spring portion;
said base portion pivotally mounted to said spring portion at a pivot point;
a screw head assembly including a head, a threaded screw portion and a pad, said screw head assembly being disposed at an end of said spring portion distal from said pivot point;
the height of said pad being adjustable by rotation of said screw portion; and
said spring portion and base portion being configured to bring said pad down when said spring portion is squeezed by the palm of a user.

18. A method for actuating a control on a video game, comprising:
providing a video game controller accessory according to claim 17;
affixing the base portion to a surface of a video game controller with the pad being disposed above a button of the video game controller; and
squeezing the spring portion relative to the base portion to bring the pad in contact with said button.

19. An accessory for a video game controllers, comprising:
a lever;
an adhesive disposed on said lever for attaching said lever to a body of the video game controller;
a screw head assembly including a head portion and a pad portion separated by a screw portion, said screw portion disposed at an end of said lever distal from said adhesive; and
said lever including a bend therein placing one end of said lever in a different plane than the other end of said lever.

20. A method for using an accessory for a video game controller according to claim 19, comprising:
aligning said pad portion over a button of the video game controller;
after said aligning step, affixing said lever to a body of the video game controller, with said adhesive; and
squeezing said lever to contact said button with said pad portion during the course of playing a video game.
